(19) United States
(12) Patent Application Publication
(10) Pub. No.: US 2023/0327291 A1
(43) Pub. Date: Oct. 12, 2023

(54) ELECTRICAL CONNECTOR TO CONNECT THE TERMINALS OF TWO ADJACENT BATTERY MODULES TO ONE ANOTHER IN A POWER STORAGE SYSTEM

(71) Applicant: FERRARI S.P.A., Modena (IT)

(72) Inventors: Luca POGGIO, Modena (IT); Elena LIGABUE, Modena (IT); Enrico VENTURI, Modena (IT)

(21) Appl. No.: 18/194,976

(22) Filed: Apr. 3, 2023

(30) Foreign Application Priority Data
Apr. 6, 2022 (IT) 102022000006839

(51) Int. Cl. H01M 50/505; H01M 50/517; H01M 50/172

(52) U.S. Cl. CPC H01M 50/505; H01M 50/517; H01M 50/172

(57) ABSTRACT

An electrical connector to connect the terminals of two adjacent battery modules to one another in a power storage system. The electrical connector has: a conductor bar, which is provided with two first through holes and is configured to be laid on the two terminals of the two battery modules; two screws, each arranged through a first through hole of the conductor bar with a clearance and configured to be screwed into a threaded hole of a corresponding terminal; and a retaining sheet, which is laid on the conductor bar and has two second through holes, each aligned with a corresponding first through hole. Each screw is screwed into the corresponding second through hole.

### CROSS-REFERENCE TO RELATED APPLICATIONS

This patent application claims priority from Italian patent application no. 102022000006839 filed on Apr. 6, 2022, the entire disclosure of which is incorporated herein by reference.

### TECHNICAL FIELD

The invention relates to an electrical connector to connect the terminals of two adjacent battery modules to one another in a power storage system.

### PRIOR ART

A vehicle can be provided with one single electric motor or with several electric motors (in which case, the drive is a full electric drive) or it can be provided with one or more electric motors combined with a combustion engine (in which case, the drive can be a full electric drive, a combustion drive or a hybrid drive).

The electric motor (or each electric motor) is mechanically connected to the drive wheels and is electrically connected to a power storage system through the interposition of an electronic power converter.

The power storage system consists of two groups of electrochemical cells (usually with a “pouch” structure or with a prismatic structure) connected to one another in series (in order to increase the total electrical voltage). The power storage system can have large dimensions and great weights (especially in case of a full electric drive in which the power storage system can weigh more than 500 kg).

In modern vehicles, the power storage system has a flat and (relatively) thin conformation so that it can be integrated in the floorboard of the vehicle. In this arrangement, the power storage system comprises a container having a lower wall (which constitutes the bottom of the vehicle facing the road surface), an upper wall and a side wall, which is perpendicular to the lower and upper walls and connects the lower and upper walls to one another. Inside the container there are the different groups of electrochemical cells, each forming a corresponding battery module.

Patent application US2018114961A1 discloses a power storage system for a vehicle comprising a plurality of battery modules, which are adjacent to one another and are mounted on a base plate; in order to couple the battery modules to the base plate, each battery module is provided with tubular and hollow connection bodies, into which respective screws are inserted, which are screwed into threaded holes made in the base plate.

Patent application EP21206804.3 discloses a power storage system for a vehicle comprising: a container provided with a lower wall; and a plurality of battery modules, which are housed inside the container. Each battery module has a group of electrochemical cells and two containing walls, which are oriented perpendicularly to the lower wall of the container and are arranged parallel to one another on opposite sides of the group of electrochemical cells so as to clamp the group of electrochemical cells between them; each containing wall has at least one tubular connection body and there are a plurality of locking pins, which are fixed to the lower wall, perpendicularly project from the lower wall and engage the connection bodies.

Besides mechanically fixing the battery modules inside the container of the power storage system, the battery modules also need to be connected to one another (typically in series). In particular, two adjacent battery modules have two corresponding terminals (each consisting of a copper block having, at the centre, a threaded hole), which have to be electrically connected to one another by means of an electrical connector. The electrical connector comprises a copper conductor bar, which is sized so as to be laid (forming a “bridge”) on the terminals of the two adjacent battery modules and has, at its ends, two through holes; once the conductor bar of the electrical connect has been laid on the terminals of the two adjacent battery modules, two screws are inserted into the through holes of the conductor bar in order to be screwed into the threaded holes of the corresponding terminals.

U.S. Pat. No. 7,667,952B2 and patent application US2017352964A1 disclose an electrical connector to connect the terminals of two adjacent battery modules to one another in a power storage system; in particular, the electrical connector comprises a conductor bar, which is provided with two through holes and is configured to be laid on the two terminals of the two battery modules, and two screws, each arranged through a through hole of the conductor bar with a clearance and configured to be screwed into a threaded hole of a corresponding terminal.

### DESCRIPTION OF THE INVENTION

The object of the invention is to provide an electrical connector to connect the terminals of two adjacent battery modules to one another in a power storage system, said electrical connector making the connection safer, reducing the electrical resistance of the connection and, at the same time, being easy and economic to be manufactured.

According to the invention, there is provided an electrical connector to connect the terminals of two adjacent battery modules to one another in a power storage system as claimed in the appended claims.

The appended claims describe preferred embodiments of the invention and form an integral part of the description.

### BRIEF DESCRIPTION OF THE DRAWINGS

The invention will now be described with reference to the accompanying drawings showing a non-limiting embodiment thereof, wherein:

FIG. 1 is an exploded perspective view, with parts removed for greater clarity, of a power storage system of a vehicle;

FIG. 2 is a plan view, with part removed for greater clarity, of two modules of the power storage system of FIG. 1 connected to one another by an electrical connector according to the invention;

FIGS. 3 and 4 are two different exploded perspective views of the electrical connector of FIG. 2; and

FIG. 5 is a cross-section view of the electrical connector of FIG. 2.

### PREFERRED EMBODIMENTS OF THE INVENTION

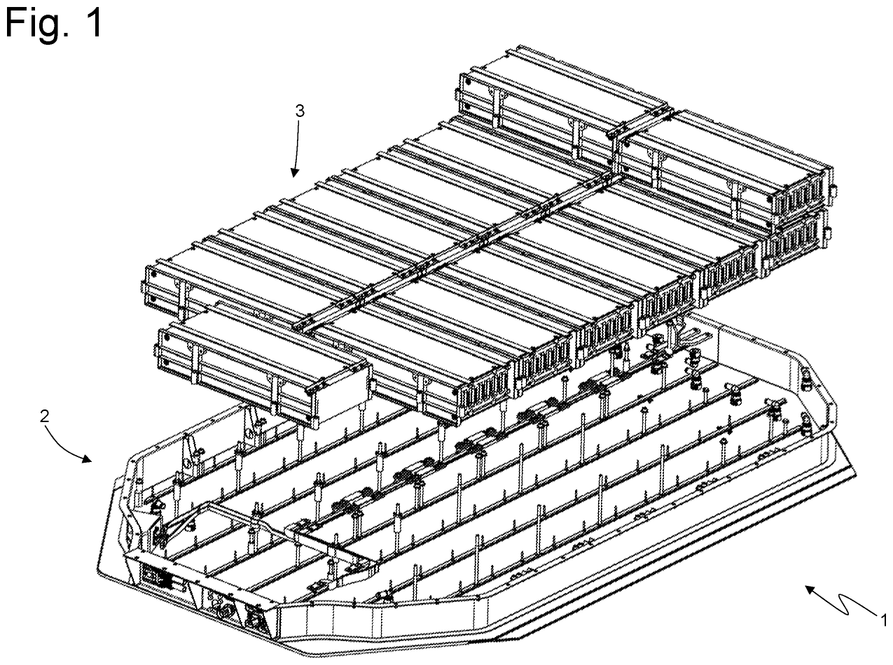

In FIG. 1, number 1 indicates, as a whole, a power storage system of a road vehicle (in particular, a car) provided with chemical batteries.

The power storage system 1 comprises a container 2 and a plurality of battery modules 3 (in particular, fifteen battery modules 3), each arranged in the container 2, (at first) separate from and independent of the other battery modules 3 and accommodating, on the inside, a group of electrochemical cells with a parallelepiped shape (namely, having a “pouch” structure or a prismatic structure).

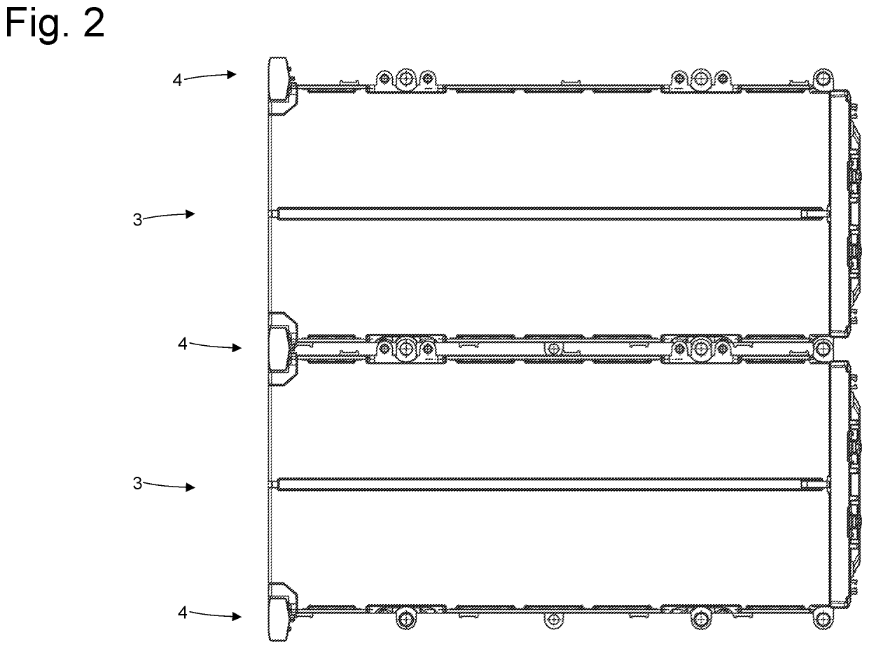

According to FIG. 2, the different battery modules 3 are electrically connected to one another in series by means of a plurality of electrical connectors 4.

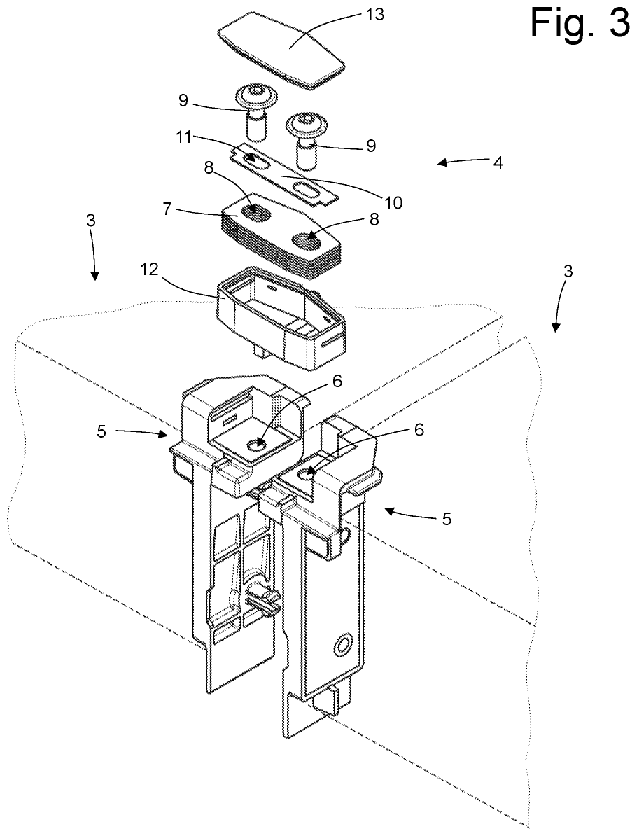

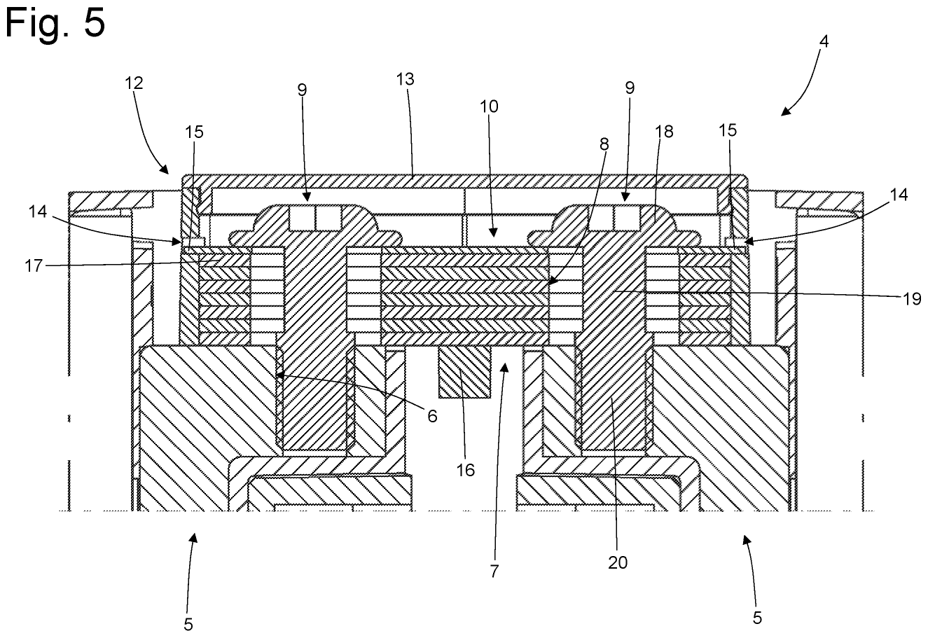

According to FIGS. 3 and 5, each electrical connector 4 connects the terminals 5 of two adjacent battery modules 3 to one another; in particular, each terminal 5 has a threaded dead hole 6 to create the mechanical connection of the corresponding electrical connector 4.

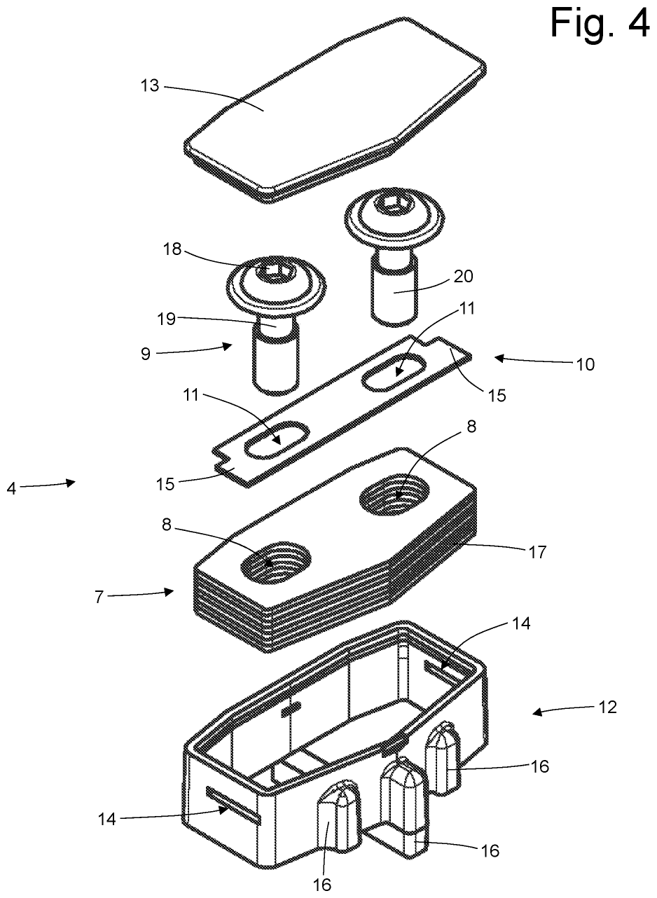

According to FIGS. 3, 4 and 5, each electrical connector 4 comprises a conductor bar 7 (usually made of copper), which is provided with two through holes 8 at the ends and is configured to be laid on the two terminals 5 of the battery modules 3. Furthermore, each electrical connector 4 comprises two screws 9, each arranged through a through hole 8 of the conductor bar 7 with a clearance and screwed (namely, configured to be screwed) into a threaded hole 7 of a corresponding terminal 5.

Each through hole 8 of the conductor bar 7 has larger dimensions than a diameter of the corresponding screw 9 so as to allow the corresponding screw 9 to move inside the through hole 8 with a given clearance, so that its position can be adjusted in order to make up for building tolerances. According to a preferred embodiment, each through hole 8 of the conductor bar 7 has a longitudinal size that is greater than a transverse size (namely, each through hole 8 has an oblong shape, with the longitudinal size prevailing over the transverse size) and both the longitudinal size and the transverse size of each through hole 8 are greater than the diameter of the corresponding screw 9 so as to allow the corresponding screw 9 to move inside the through hole 8 with a given clearance both longitudinally and transversely (so that its position can be adjusted in order to make up for building tolerances).

Each electrical connector 4 comprises a retaining sheet (usually made of copper), which is laid on the conductor bar 7 and has, at the ends, two through holes 11, each aligned with a corresponding through hole 8. Each screw 9 is screwed into the corresponding through hole 11; namely, in order to be inserted through the corresponding through hole 11, it has to be screwed into the corresponding through hole 11; in other words, the thread of each screw 9 does not allow the screw 9 to go through the corresponding hole 11, if not through a screwing operation (namely, an outer diameter of the thread of each screw 9 is larger than a width of the corresponding through hole 11).

According to a preferred embodiment, each through hole 11 of the retaining sheet 10 has a longitudinal size that is greater than a transverse size (namely, each through hole 11 has an oblong shape, with the longitudinal size prevailing over the transverse size), thus reproducing the shape of the through holes 8 of the conductor bar 7. Each through hole 11 of the retaining sheet 10 has a longitudinal size that is greater than the outer diameter of the thread of each screw 9 and a transverse size that is (slightly) smaller than the outer diameter of the thread of each screw 9 (hence, the screw 9 has to be screwed into the through hole 11 in order to be inserted into the through hole 11).

The two screws 9 are previously screwed into the through holes 11 of the retaining sheet 10 and this constrains the two screws 9 to the retaining sheet 10; in this way, the screws 9 (which cannot be removed from the retaining sheet 10, if not by being unscrewed through the through holes 11 of the retaining sheet 10) always remain coupled to the retaining sheet 10 and cannot get “lost” following a wrong or clumsy handling of an operator.

Each electrical connector 4 comprises a shell 12, which is made of an electrically insulating material, is open at the top and at the bottom and contains, on the inside, the conductor bar 7; preferably (though not necessarily), each electrical connector 4 also comprises a lid 13, which is made of an electrically insulating material and is coupled to the shell 12 in order to close the shell 12 at the top. The shell 12 could be overmoulded around the conductor bar 7 or the conductor bar 7 could be inserted (with force) into the previously moulded shell 12 (usually through a given elastic deformation of the shell 12).

According to a preferred embodiment, the retaining sheet 10 is contained (inserted, locked) inside the shell 12, so that it cannot be removed from the shell 12 once it is coupled to the screws 9; in this way, the screws 9 (which cannot be removed from the retaining sheet 10, if not by being unscrewed through the through holes 11 of the retaining sheet 10) always remain coupled to the shell 12 (hence, to the electrical connector 4) and cannot get “lost” following a wrong or clumsy handling of an operator.

According to a preferred embodiment, the retaining sheet 10 is contained in the shell 12, thus allowing the retaining sheet 10 to make (limited) transverse movements (namely, movements in a plane that is perpendicular to a longitudinal axis of the screws 9); in this way, the retaining sheet 10, to which the screws 9 are constrained, can (slightly) adjust its position in order to make up for building tolerances. In other words, the retaining sheet 10 can make (limited) transverse movements (namely, movements in a plane that is perpendicular to a longitudinal axis of the screws 9) inside the shell 12.

On the other hand, the conductor bar 7 is completely locked in the shell 12 and, hence, cannot make any movement relative to the shell 12.

In particular, the shell 12 laterally has two opposite through slits 14, through which the retaining sheet 10 can be inserted inside the shell 12 (alternatively, there could be one single through slit 14 arranged on one single side). The retaining sheet 10 preferably is longer than an inner space of the shell 12 so that the retaining sheet 10 can be arranged inside the shell 12 only by engaging, on both sides, the corresponding slits 14. In this way, when the screws 9 have been inserted (screwed) into the corresponding through holes 11 of the retaining sheet 10, the retaining sheet 10 cannot be removed from the slits 14, because this movement is forbidden by the presence of the screws 11, and the retaining sheet 10 cannot be removed in an upward direction, because this movement is forbidden by the ends of the retaining sheet 10 arranged inside the corresponding slits 14; therefore, the assembly consisting of the retaining sheet and of the screws 9 inserted (screwed) into the corresponding through holes 11 of the retaining sheet 10 cannot be separated from the shell 12 (if not by unscrewing each screw 9 from the corresponding through hole 11).

According to a preferred embodiment, a central part of the retaining sheet 10 of each electrical connector 4 has a width that is substantially the same as the width of the slits 14 (so as to substantially engage the slits 14 without a clearance), whereas, at the two ends, the retaining sheet of each electrical connector 4 has two appendages 15 with a smaller width than the central part and, when the retaining sheet 10 is inserted in the shell 12, the appendages 15 of the retaining sheet 10 engage the corresponding slits 14 (namely, they are inside the corresponding slits 14).

According to a preferred embodiment, the through slits 14 of the shell 12 are misaligned relative to the through holes 8 of the conductor bar 7, so that, once it is inserted through a slit 14, the retaining sheet 10 has to be translated perpendicularly to the through slit 14 in order to align the through holes 11 of the retaining sheet 10 with the corresponding through holes 8 of the conductor bar 7; this translation of the retaining sheet 10 is enabled by the presence of the appendages 15 with a smaller width at the two ends of the retaining sheet 10. The asymmetric arrangement of the appendages 15 of the retaining sheet 10 makes sure that the retaining sheet 10 can correctly be inserted only with one single orientation (namely, if the retaining sheet 10 is inserted with a contrary, hence undesired orientation, the through holes 11 of the retaining sheet 10 cannot be aligned with the corresponding through holes 8 of the conductor bar 7).

According to a preferred embodiment, the shell 12 of each electrical conductor 4 comprises protuberances 16, which have an asymmetric position or conformation relative to the shell 12 and are configured to engage respective openings of the power storage system 1 only when the shell 12 has one single predetermined orientation. Namely, the protuberances 16 ensure that each electrical connector 4 can always be mounted in the power storage system 1 only with one single predetermined orientation, thus avoiding any kind of positioning error.

According to a preferred embodiment, the conductor bar 7 of each electrical connector 4 consists of a plurality of sheets 17, which are identical to one another and overlap one another; in this way, the conductor bar 7 is more flexible and, therefore, can more easily adjust to possible imperfections due to building tolerances (namely, the greater flexibility of the conductor bar 7 allows it to better make up for building tolerances). In other words, the sheet-like structure of the conductor bar 7 significantly increases the flexibility of the conductor bar 7, ensuring a greater ability to make up for building tolerances. By way of example, the conductor bar 7 could consist of six-eight sheets 17 identical to one another and overlapping one another, each having a thickness of circa one millimetre.

According to a preferred embodiment, each screw 9 consists of a head 18 and a cylindrical body, which projects from the head 18 and has an intermediate portion 19 without thread, which is arranged in contact with the head 18, and a threaded end portion 20, which is arranged opposite the head 18; the threaded end portion 20 is screwed into a corresponding threaded hole 8 of the conductor bar 7, whereas the intermediate portion 19 without thread is on the outside of the corresponding threaded hole 8 of the conductor bar 7. The intermediate portion 19 without thread of each screw 9 preferably has a smaller diameter than a diameter of the threaded end portion 20, so that the intermediate portion 19 has a clearance in all directions relative to the corresponding through hole 11 of the retaining sheet 10; in other words, the threaded end portion 20 can go through the corresponding through hole 11 of the retaining sheet 10 only after a screwing, whereas the intermediate portion 19 can be “loose” inside the corresponding through hole 11 of the retaining sheet 10 with a given clearance.

According to a preferred embodiment, in each screw 9, the intermediate portion 19 without thread has a length that is (at least) the same as the length of the threaded end portion 20; in this way, when the electrical connector 4 is laid on the terminals 5, both screws 9 can freely slide upwards (while waiting to be screwed into the corresponding threaded holes 6 of the terminals 5) thanks to the clearance present between each intermediate portion 19 and the corresponding through hole 11 of the retaining sheet 10, always keeping the electrical connector 4 horizontal (hence, permitting a simple and ideal screwing of the screws 9 into the corresponding threaded holes 6 of the terminals 5, without causing, during the screwing of the screws 9, any tension in the conductor bar 7 and in the terminals 5).

The embodiments described herein can be combined with one another, without for this reason going beyond the scope of protection of the invention.

The electrical connector 4 described above has numerous advantages.

First of all, the electrical connector 4 disclosed above allows the terminals 5 of two adjacent battery modules 3 to be connected to one another creating a stable electrical connection with a low electrical resistance, even in the presence of relatively great building tolerances.

The electrical connector 4 disclosed above ensures an electrical insulation both during mounting operations and during maintenance operations.

The electrical connector 4 disclosed above offers to those operators who handle and install the electrical connector 4 a high degree of safety, since the screws 9 of the electrical connector 4 cannot get lost in any way; indeed, losing the screws 9 can pose a significant problem, for finding a lost screw 9 between the modules 3 is complicated (the space is very small) and dangerous (there always is the risk of accidentally touching a part under voltage).

Finally, the electrical connector 4 disclosed above allows the terminals 5 of two adjacent battery modules 3 to be electrically connected to one another in a simple and quick fashion.

### LIST OF THE REFERENCE NUMBERS OF THE FIGURES

1 power storage system
2 container
3 battery module
4 electrical connector
5 terminals
6 threaded hole
7 conductor bar
8 through holes
9 screws
10 retaining sheet
11 through holes
12 shell
13 lid
14 through slit
15 appendages
16 protuberance
17 sheets
18 head
19 intermediate portion
20 end portion

1) An electrical connector (4) to connect the terminals (5) of two adjacent battery modules (3) to one another in a power storage system (1); the electrical connector (4) comprises:
a conductor bar (7), which is provided with two first through holes (8) and is configured to be laid on the two terminals (5) of the two battery modules (3);
a retaining sheet (10), which is laid on the conductor bar (7) on the opposite side relative to the terminals (5) of the two battery modules (3) and has two second through holes (11), each aligned with a corresponding first through hole (8); and
two screws (9), each arranged through a second through hole (9) of the retaining sheet (10) and through a first through hole (8) of the conductor bar (7) and configured to be screwed into a threaded hole (7) of a corresponding terminal (5);
wherein each screw (9) is arranged through the corresponding first through hole (8) with a clearance; and
wherein each screw (9) is screwed into the corresponding second through hole (11).

2) The electrical connector (4) according to claim 1 and comprising a shell (12), which is made of an electrically insulating material, is open at the top and at the bottom and contains, on the inside, the conductor bar (7) and the retaining sheet (10).

3) The electrical connector (4) according to claim 2 and comprising a lid (13), which is made of an electrically insulating material and is coupled to the shell (12) so as to close the shell (12) at the top.

4) The electrical connector (4) according to claim 2, wherein the conductor bar (7) is completely locked in the shell (12) and, hence, cannot make any movement relative to the shell (12).

5) The electrical connector (4) according to claim 2, wherein the retaining sheet (10) is contained in the shell (12), thus allowing the retaining sheet (10) to make transverse movements, namely movements in a plane that is perpendicular to a longitudinal axis of the screws (9).

6) The electrical connector (4) according to claim 2, wherein the retaining sheet (10) is inserted inside the shell (12) so that it cannot be extracted from the shell (12) once it is coupled to the screws (9).

7) The electrical connector (4) according to claim 6, wherein the shell (12) laterally has at least one through slit (14), through which the retaining sheet (10) can be inserted into the shell (12).

8) The electrical connector (4) according to claim 7, wherein the shell (12) laterally has two through slits (14) opposite one another and the retaining sheet (10) is longer than an inner space of the shell (12) so that the retaining sheet (10) can be arranged inside the shell (12) only by engaging, on both sides, the corresponding slits (14).

9) The electrical connector (4) according to claim 8, wherein, at the two ends, the retaining sheet (10) has two appendages (15) with a smaller width compared to a central part of the retaining sheet (10).

10) The electrical connector (4) according to claim 7, wherein the through slit (14) is misaligned relative to the first through holes (8) so that the retaining sheet (10), once it is inserted through the through slit (14), has to be translated perpendicularly to the through slit (14) in order to align the second through holes (11) with the corresponding first through holes (8).

11) The electrical connector (4) according to claim 2, wherein the shell (12) comprises at least one protuberance (16), which has an asymmetric position or conformation relative to the shell (12) and is configured to engage an opening of the power storage system (1) only when the shell (12) has one single predetermined orientation.

12) The electrical connector (4) according to claim 1, wherein the conductor bar (7) consists of a plurality of sheets (17) identical to one another and overlapping one another.

13) The electrical connector (4) according to claim 1, wherein each screw (9) consists of a head (18) and of a cylindrical body, which projects from the head (18) and has an intermediate portion (19) without thread and arranged in contact with the head (18) and a threaded end portion (20) arranged on the side opposite the head (18).

14) The electrical connector (4) according to claim 13, wherein the intermediate portion (19) without thread of each screw (9) has a smaller diameter than a diameter of the threaded end portion (20).

15) The electrical connector (4) according to claim 13, wherein the intermediate portion (19) without thread of each screw (9) has a length that is at least the same as the length of the threaded end portion (20).
